(19) United States
(12) Patent Application Publication
(10) Pub. No.: US 2014/0104885 A1
(43) Pub. Date: Apr. 17, 2014

(54) LIGHT GUIDE PLATE, BACKLIGHT MODULE AND DISPLAY DEVICE

(71) Applicants: BEIJING BOE DISPLAY TECHNOLOGY CO., LTD., Beijing (CN); BOE TECHNOLOGY GROUP CO., LTD., Beijing (CN)

(72) Inventors: Zhidan ZHANG, Beijing (CN); Qing MA, Beijing (CN); Hao ZHOU, Beijing (CN); Sijun LEI, Beijing (CN); You LI, Beijing (CN); Hai CHI, Beijing (CN)

(73) Assignees: BEIJING BOE DISPLAY TECHNOLOGY CO., LTD., Beijing (CN); BOE TECHNOLOGY GROUP CO., LTD., Beijing (CN)

(21) Appl. No.: 14/052,317

(22) Filed: Oct. 11, 2013

(30) Foreign Application Priority Data
Oct. 11, 2012 (CN) 201210384698.2

(51) Int. Cl. F21V 8/00

(52) U.S. Cl. CPC G02B 6/0036
USPC 362/626; 362/625

(57) ABSTRACT

Embodiments of the present invention provide a light guide plate, a backlight module and a display device. The light guide plate having at least one side for placing a light source assembly comprising a plurality of light source units, wherein a plurality of microstructure protrusions are provided on the inner side of the bottom surface of the light guide plate, in regions close to the light source assembly, and the microstructure protrusions are provided with at least one reflective surface, which faces toward the regions of the light guide plate corresponding to the gaps between the light source units.

### BACKGROUND

Embodiments of the invention relate to a light guide plate, a backlight module and a display device.

As display devices have become widely used in the fields of television, computers, monitors, mobile phones and digital cameras, a display device with high quality is increasingly requested. A Light and thin display device with high light efficiency, low radiation, low power consumption has become a research trend.

A display device mainly comprises a display panel and a backlight module, wherein the backlight module is used to provide sufficient and uniform illumination for the display panel, so as to ensure a high display quality. An edge-lit backlight module, as one of the most widely used type of backlight module, comprises a light guide plate and a light source assembly at least provided on a side of the light guide plate, wherein light from the light source assembly enters the light guide plate from the side, continuously undergoes diffusion within the light guide plate, and uniformly exit the light guide plate from a light exiting surface thereof, so as to provide illumination for a display device. Light-emitting diodes (LEDs), due to their advantages such as high luminous efficiency, long service life and environmental safety, have gradually replaced traditional cold cathode fluorescent lamps (CCFLs) to be used in a light source assembly.

However, the following defects in the existing backlight module have been found. Since a LED light source assembly is comprised of a plurality of light source units each of which has a particular shape and a particular light emitting angles, dark zones tends to appear in the regions of a light guide plate corresponding to the gaps between the light source units; that is, insufficient illumination is generated, which in turn lead to non-uniform light distribution within the light guide plate.

### SUMMARY

An embodiment of the present invention provides a light guide plate having at least one side for placing a light source assembly comprising a plurality of light source units, wherein a plurality of microstructure protrusions are provided on the inner side of the bottom surface of the light guide plate, in regions close to the light source assembly, and the microstructure protrusions are provided with at least one reflective surface, which faces toward the regions of the light guide plate corresponding to the gaps between the light source units.

Another embodiment of the present invention provides a backlight module comprising the light guide plate described as above.

A further embodiment of the present invention provides a display device comprising the backlight module described as above.

### BRIEF DESCRIPTION OF THE DRAWINGS

In order to clearly illustrate the technical solutions of the embodiments of the present invention, the accompanying drawings of the embodiments will be briefly described in the following; it is obvious that the following description of the drawings only relates to some embodiments of the invention and thus not limitative of the invention.

FIG. 1 is a schematic top view of a light guide plate in accordance with an embodiment of the present invention.

FIG. 2 is a schematic top view of a light guide plate in accordance with an embodiment of the present invention.

FIG. 3 is a schematic diagram showing the structure of microstructure protrusions within a light guide plate in accordance with an embodiment of the present invention.

FIG. 4 is a schematic diagram showing the structure of microstructure protrusions within a light guide plate in accordance with an embodiment of the present invention.

FIG. 5 is a schematic diagram showing the structure of microstructure protrusions within a light guide plate in accordance with an embodiment of the present invention.

### DETAILED DESCRIPTION

In connection with the accompanying drawings of the embodiments of the present invention, the technical solutions of the embodiments will be described in a clear and fully understandable way; it is obvious that the described embodiments are just one part but not all of the embodiments of the invention. Other embodiment(s) obtained by those skilled in the art, based on the embodiments of the present invention, without any inventive work, all belong to the protection scope of the present invention.

One of the technical problem to be solved by embodiments of the present invention is to provide a light guide plate, a backlight module and a display device, capable of reflecting light from light source units and entering into the light guide plate toward the regions of the light guide plate corresponding to the gaps between the light source units, so as to enhance the brightness of the regions of the light guide plate corresponding to the gaps between the light source units.

In the following description, for purposes of illustration and not for limitation, specific details, such as particular system structures, interfaces, techniques, are given in order to provide a thorough understanding of the present invention. However, those skilled in the art should be clear that the present invention can also be implemented in other embodiments without these specific details. In some cases, a detailed description of the well-known devices, circuits, and method are omitted, so as to avoid obscuring this description of the present invention with unnecessary details.

It needs to be noted that, for convenience of description, spatial relation terms such as “bottom surface”, “side surface”, and “inner side” are used to describe one component or feature shown in the figures with respect to another component or feature. In addition to orientations illustrated in the figures, spatial relation terms are also used to describe different orientations of a device in use or operation. Spatial relationship terms in this embodiment, with reference to the accompanying drawings, are intended only to illustrate, not limit the present invention.

Below, in connection with the accompanying drawings, embodiments of the present invention will be described in detail.

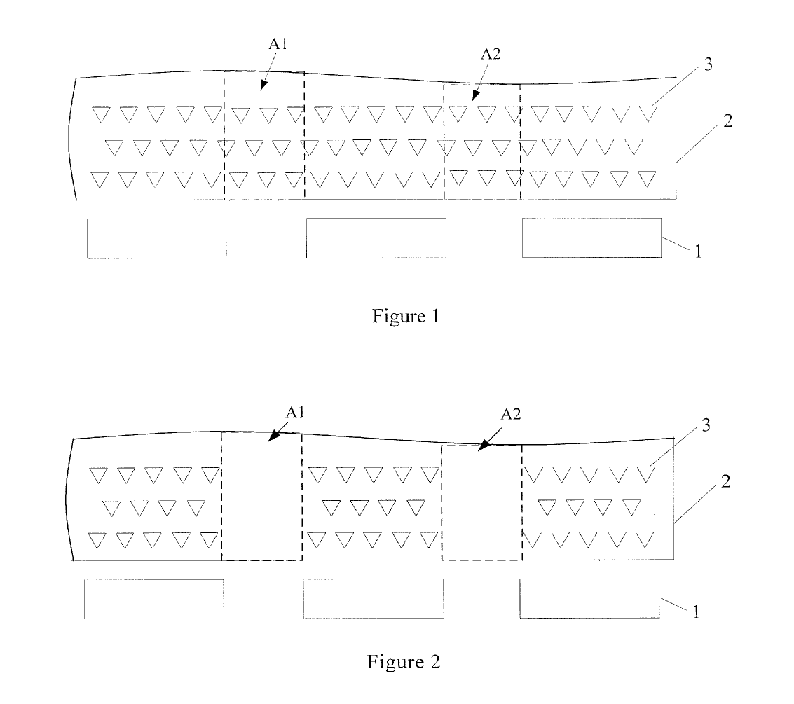

As shown in FIG. 1, this embodiment provides a light guide plate 2. A light source assembly comprising a plurality of light source units 1 is provided on a side of the light guide plate 2. The side surface of light guide plate 2, which faces toward the light source units 1 of the light source assembly, for example, is the light entering surface of the light guide plate 2; the surface of light guide plate 2, from which the light entering the light guide plate 2 exit, for example, is the light exiting surface of light guide plate 2. In an edge-lit backlight module, the light entering surface and light exiting surface of the light guide plate 2 are provide adjacent to each other, and the surface opposing the light exiting surface, for example, is the bottom surface of the light guide plate 2. In this embodiment, a plurality of microstructure protrusions 3 are provided in a inner side of the bottom surface of the light guide plate 2 and close to the light source assembly. Herein, the inner side of the bottom surface of light guide plate 2 refers to the side of the bottom surface of light guide plate 2, which faces toward the interior of light guide plate 2. Microstructure protrusions 3, for example, are formed to be internal protrusions on the bottom surface of light guide plate 2, protruding toward the interior of light guide plate 2. Each microstructure protrusion 3, for example, is provided with two side surfaces coated with high reflectivity material, and each of the two side surfaces faces respectively toward the regions in light guide plate 2 corresponding to different gaps between the light source units 1, for example, region A1 and region A2 shown in the dashed box in FIG. 1. The above-described region A1 and region A2, for example, are formed at two opposite sides of the same light source unit 1.

It needs to be noted that, the light source assembly in this embodiment can be provided to face more than one side surface of the light guide plate, for example, two opposite side surfaces of the light guide plate. Namely, in this case, the light guide plate can have two light entering surfaces facing away from each other. Correspondingly, microstructure protrusions can be provided on the inner side of the bottom surface of the light guide plate and close to the two light source assembly.

As shown in FIG. 1, the plural light source units 1 are located on one side of light guide plate 2. Light emitted from the light source units 1 enters into the light guide plate 2 and travels within the light guide plate 2. Due to the two side surfaces of the microstructure protrusions 3 which are coated with high reflectivity material and face toward, for example, region A1 and region A2 in the light guide plate 2 respectively, light impinged onto the microstructure protrusions 3 provided on the inner side of the bottom surface of light guide plate 2 is reflected toward region A1 and region A2 in the light guide plate 2 that are corresponding to the different gaps between the light source units 1. Therefore, light distribution within the light guide plate 2 is more uniform, capable of improving the display quality of a display panel.

Alternatively, another embodiment of the present invention provides a light guide plate, as shown in FIG. 2, wherein microstructure protrusions 3 are provided on the inner side of the bottom surface of the light guide plate 2 and close to each light source unit 1. That is, microstructure protrusions 3 can merely be provided in the regions of the light guide plate 2 corresponding to the light source units 1 rather than the region A1 and region A2 of the light guide plate 2 that are corresponding to different gaps between light source units 1. By matching the microstructure protrusions 3 with the light source units 1 having particular shapes and light emitting angles, light is reflected toward the region A1 and region A2 in the light guide plate that are corresponding to the gaps between the light source units 1. Microstructure protrusions 3 can be used more effectively when they are provided in the regions close to each light source unit 1.

Furthermore, microstructure protrusions 3 may be in any one of the forms such as triangular prism, triangular pyramid, rectangular prism and rectangular pyramid. Of course, microstructure protrusions constituting a microstructure protrusion arrays can be in any one or more forms described as above.

Between the two reflective side surfaces of the microstructure protrusion 3 which face toward the regions in the light guide plate corresponding to different gaps between the light source units 1, for example, an angle of 60 degrees to 120 degrees is formed. In addition, the angle between these two side surfaces and the bottom surface of the light guide plate 2, which is connected with factors such as the distance between the light source units and the light-emitting angles of the light source units, can be determined on the basis of several factors, thereby not particularly limited herein.

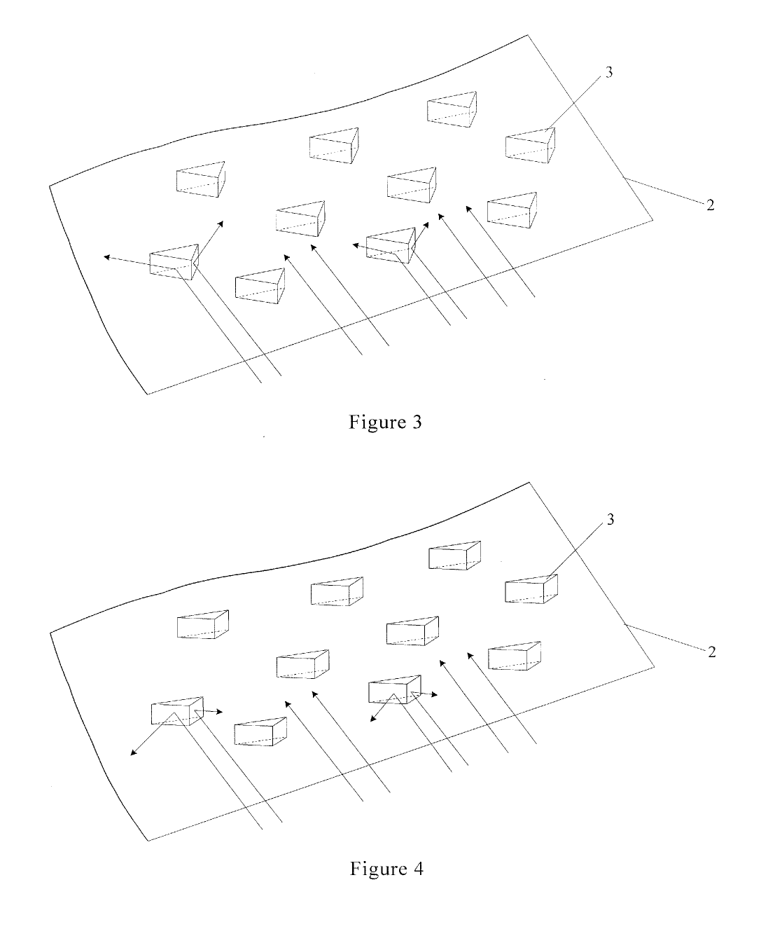

In an embodiment of the present invention, as shown in FIG. 3, the microstructure protrusions 3 are in the form of a triangular prism, and their two reflective side surfaces, which face toward the regions in the light guide plate corresponding to the gaps between light source units 1, form an angle of 60 degrees. Since both these two side surfaces of the microstructure protrusions 3 described as above are coated with high reflectivity material, light impinged onto microstructure protrusions 3 will be reflected toward the region A1 and region A2 in the light guide plate 2 that are corresponding to the gaps between light source units 1, thereby improving light distribution uniformity within the light guide plate.

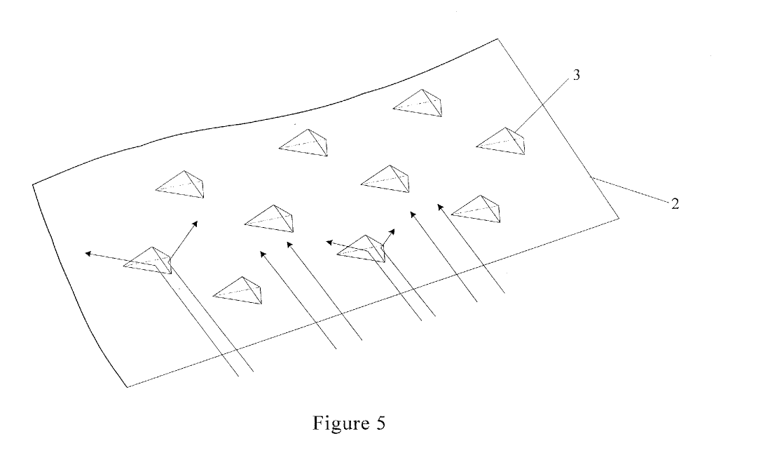

In another embodiment of the present invention, as shown in FIG. 4, the microstructure protrusions 3 are in the form of a triangular prism, and their two reflective surfaces, which face toward the regions in the light guide plate 2 corresponding to the gaps between light source units 1 (for example, the region A1 and region A2 shown in FIG. 1 and FIG. 2), form an angle of 120 degrees. Similarly, since both these two side surfaces of microstructure protrusions 3 are coated with high reflectivity material, light impinged onto the microstructure protrusions 3 will be reflected toward the region A1 and region A2 in the light guide plate that are corresponding to the gaps between the light source units 1.

It is understood by those skilled in the art that when the angle between the two side surfaces of the microstructure protrusions, which face toward the regions in the light guide plate 2 corresponding to the gaps between the light source unit 1, is changed, only the direction of the reflected light is changed as a result. These two side surfaces, regardless of the angle therebetween, can reflect light toward the above-described regions of the light guide plate, thereby improving light distribution uniformity within the light guide plate. Therefore, the value of the angle between these two side surfaces of the microstructure protrusions herein are only illustrative; in practical applications, the value can be set and chosen, according to the needs of practical need, so as to fulfill all or part of the above-described functions. The value can be set and chosen by referring to the corresponding process in the above-described embodiments, therefore not described in detail herein.

In another embodiment of the present invention, as shown in FIG. 5, the microstructure protrusions 3 are in the form of a triangular pyramid.

In addition, the microstructure protrusions also can be in the form of a rectangular prism or a rectangular pyramid, not particularly limited herein. When the microstructure protrusions are in the form of a pyramid, their apex angles can be rounded.

Furthermore, the distance between the microstructure protrusions 3, for example, is 0.1 mm. The edge length of the bottom surface of each microstructure protrusion 3 is, for example, 0.05 mm, and the height of each microstructure protrusion is, for example, 0.03 mm.

In an embodiment of the present invention, the plural microstructure protrusions 3 are arranged in an array on the bottom surface of light guide plate 2. For example, as shown in FIG. 3, the plural microstructure protrusions 3 form a 20×20 array, wherein the microstructure protrusions in adjacent rows can be staggered, namely, two adjacent rows of microstructure protrusions can be shifted from each other, so as to allow more light to be reflected by the microstructure protrusions 3. Alternatively, the microstructure protrusions 3 can be arranged in accordance with the features of light source units and requirements for image uniformity.

In an embodiment of the present invention, the microstructure protrusions 3 are formed by laser process or injection molding process. In addition, the microstructure protrusions also can be formed by other known techniques that are used to produce microstructure protrusions in a light guide plate.

In an example of the present invention, the microstructure protrusions 3 can be an air-filled hollow structure.

In another embodiment of the present invention, the microstructure protrusions 3 can be made of any organic or inorganic materials t different from the material of the light guide plate 2.

It should be understood that, although microstructure protrusions in the above-described embodiments are all provided with two reflective surfaces, they can also be provided with only one reflective surface or more than two reflective surfaces, facing toward, for example, the region A1 and A2 in the light guide plate. In addition, according to practical need, the microstructure protrusions can be provided at different locations with different reflective surfaces, so as to improve light distribution uniformity within the light guide plate.

In the light source unit of the embodiments of the present invention, the plural microstructure protrusions are provided on the inner side of the bottom surface of the light guide plate and in the regions close to the light source assembly, and the microstructure protrusions are provided with (a) reflective surface(s) for reflecting light from the light source units and entering into the light guide plate toward the regions in the light guide plate corresponding to the gaps between the light source units, thereby enhancing the brightness of the regions in the light guide plate corresponding to the gaps between the light source units, which in turn improves the light distribution uniformity within the light guide plate.

An embodiment of the present invention further provides a backlight module comprising the light guide plate described as above. The backlight module, for example, further comprises: a light source assembly, including a plurality of light source units and a printed circuit board (PCB) electrically connected to the light source units, facing at least one side surface of the light guide plate, and a back plate, provided beneath the bottom surfaces of the light guide plate and the light source assembly.

An embodiment of the present invention further provides a display device comprising the backlight module described as above. The display device can be any product or component having display feature, such as a liquid crystal panel, electronic paper, OLED panel, LCD (liquid crystal display) TV, LCD monitors, digital photo frame, mobile phone, or tablet computer.

In the backlight module and display device of the embodiments of the present invention provides, light from light source units are emitted into the light guide plate and reflected toward the regions of the light guide plate corresponding to the gaps between light source units, so as to enhance the brightness of the above-described regions of the light guide plate, which in turn improves the light distribution uniformity within the light guide plate and the display quality.

According to the description above, embodiments of the present invention can provide at least the following structures:

(1) A light guide plate having at least one side for placing a light source assembly comprising a plurality of light source units, wherein a plurality of microstructure protrusions are provided on the inner side of the bottom surface of the light guide plate, in regions close to the light source assembly, and the microstructure protrusions are provided with at least one reflective surface, which faces toward the regions of the light guide plate corresponding to the gaps between the light source units.

(2) The light guide plate according to (1), wherein the microstructure protrusions are provided with two reflective surfaces, which face respectively toward the regions of the light guide plate corresponding to different gaps between the light source units.

(3) The light guide plate according to (1) or (2), wherein the reflective surface(s) of the microstructure protrusions is/are coated with high reflectivity material.

(4) The light guide plate according to any one of (1) to (3), wherein the microstructure protrusions are provided in the regions close to each light source unit.

(5) The light guide plate according to any one of (1) to (4), wherein the microstructure protrusions can be in any one of the forms including triangular prism, triangular pyramid, rectangular prism and rectangular pyramid.

(6) The light guide plate according to any one of (2) to (5), wherein the two reflective surfaces of the microstructure protrusions form an angle of 60 to 120 degrees.

(7) The light guide plate according to any one of (1) to (6), wherein the distance between the microstructure protrusions is 0.1 mm.

(8) The light guide plate according to any one of (1) to (7), wherein the bottom edge length of each of the microstructure protrusion is 0.05 mm, and the height of each of the microstructure protrusion is 0.03 mm.

(9) The light guide plate according to any one of (1) to (8), wherein the microstructure protrusions are arranged in a 20×20 array in the light guide plate.

(10) A light guide plate according to any one of (1) to (9), wherein the microstructure protrusions are formed by laser process or injection molding process.

(11) A backlight module comprising a light guide plate described as in any one of (1) to (10).

(12) A display device comprising a backlight module describe as in (11).

Although the present invention has been described in considerable detail with reference to some embodiments thereof, modifications or improvements can still be made on the basis of the embodiments of the present invention, which is evident to those skilled in the art. Therefore, those modifications and/or improvements, which are made without departing from the spirit of the present invention, all belong to the protection scope of the present invention.

What is claimed is:

1. A light guide plate having at least one side for placing a light source assembly comprising a plurality of light source units, wherein a plurality of microstructure protrusions are provided on the inner side of the bottom surface of the light guide plate, in regions close to the light source assembly, and the microstructure protrusions are provided with at least one reflective surface, which faces toward the regions of the light guide plate corresponding to the gaps between the light source units.

2. The light guide plate according to claim 1, wherein the microstructure protrusions are provided with two reflective surfaces, which face respectively toward the regions of the light guide plate corresponding to different gaps between the light source units.

3. The light guide plate according to claim 1, wherein the reflective surface(s) of the microstructure protrusions is/are coated with high reflectivity material.

4. The light guide plate according to claim 1, wherein the microstructure protrusions are provided in the regions close to the light source units.

5. The light guide plate according to claim 1, wherein the microstructure protrusions are in any one of the forms including triangular prism, triangular pyramid, rectangular prism and rectangular pyramid.

6. The light guide plate according to claim 2, wherein the microstructure protrusions are in any one of the forms including triangular prism, triangular pyramid, rectangular prism and rectangular pyramid.

7. The light guide plate according to claim 2, wherein the two reflective surfaces of the microstructure protrusions form an angle of 60 to 120 degrees.

8. The light guide plate according to claim 1, wherein the distance between the microstructure protrusions is 0.1 mm.

9. The light guide plate according to claim 2, wherein the distance between the microstructure protrusions is 0.1 mm.

10. The light guide plate according to claim 1, wherein the bottom edge length of each of the microstructure protrusions is 0.05 mm, and the height of each of the microstructure protrusions is 0.03 mm.

11. The light guide plate according to claim 2, wherein the bottom edge length of each of the microstructure protrusions is 0.05 mm, and the height of each of the microstructure protrusions is 0.03 mm.

12. The light guide plate according to claim 1, wherein the microstructure protrusions are arranged in a 20×20 array in the light guide plate.

13. The light guide plate according to claim 2, wherein the microstructure protrusions are arranged in a 20×20 array in the light guide plate.

14. The light guide plate according to claim 1, wherein the microstructure protrusions are made by laser processing or die casting.

15. The light guide plate according to claim 2, wherein the microstructure protrusions are formed by laser process or injection molding process.

16. A backlight module comprising the light guide plate according to claim 1.

17. A display device comprising the backlight module according to claim 16.
